(19) United States
(12) Patent Application Publication
(10) Pub. No.: US 2009/0142158 A1
(43) Pub. Date: Jun. 4, 2009

(54) LOCKING ASSEMBLY

(75) Inventor: BIN DAI, Shenzhen (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) Co., LTD., Shenzhen City (CN); HON HAI PRECISION INDUSTRY CO., LTD., Tu-Cheng (TW)

(21) Appl. No.: 11/962,116

(22) Filed: Dec. 21, 2007

(30) Foreign Application Priority Data
Nov. 30, 2007 (CN) 200710202794.X

(51) Int. Cl. F16B 21/18

(52) U.S. Cl. 411/353

(57) ABSTRACT

An exemplary locking assembly includes a locking member, a lock washer and a sleeve. The locking member includes a locking portion. A sleeve defines a through hole for holding and guiding the locking member. The lock washer is positioned in the through hole of the sleeve for preventing the locking portion of the locking member to slide out of the sleeve without an external force.

### CROSS-REFERENCE TO RELATED APPLICATIONS

This application is related to U.S. patent application Ser. No. 11/954,232 filed on Dec. 12, 2007, entitled “LOCKING ASSEMBLY”, and invented by Hsuan-Chen Chen. Such application has the same assignee as the present application.

### BACKGROUND OF THE INVENTION

1. Field of the Invention

The present invention generally relates to locking devices, and particularly to a locking assembly having a locking member that would not slide out of the locking assembly.

2. Discussion of the Related Art

Typically, in assembling, a plurality of locking elements, such as screws, are widely used to fix at least two members tightly.

FIG. 4 shows a conventional locking structure 10. The locking structure 10 includes a first object 12, a second object 14, and a fastener 16. The second object 14 defines a stepped hole 142 therein, and the stepped hole 142 includes a first stepped part 1422 and a second stepped part 1424. A diameter of the first stepped part 1422 is smaller than that of the second stepped part 1424 of the stepped hole 142. The first object 12 defines a threaded hole 122 therein corresponding to the second stepped part 1424 of the stepped hole 142. The fastener 16 includes a head portion 162, a neck portion 164, and a threaded portion 166. One end of the neck portion 164 connects to the head portion 162 and another end of the neck portion 164 connects to the threaded portion 166. A diameter of the neck portion 164 is smaller than that of the first stepped part 1422. The threaded portion 166 of the fastener 16 is match with the threaded hole 122 of the first object 12. In assembled, the threaded portion 166 of the fastener 16 is screwed into the threaded hole 122 of the first object 12 passing through the stepped hole 142 of the second object 14, thereby fixing the first object 12 and the second object 14 tightly.

However, in disassembling, the fastener 16 is usually detached from the first object 12 and the second object 14, and is easily misplaced or lost due to its smaller size. Therefore, it is difficult or troublesome to re-assemble the locking structure 10 with finding the fastener 16 or without the fastener 16. Especially, if the fastener 16 is a non-standard product, the re-assembling of the locking structure 10 is more difficult. In addition, if the locking structure 10 is located in an inner portion of an electronic product (not shown) adjacent to gaps or holes of the electronic product, the fastener 16 may be detached from the first object 12 and the second object 14 and fall into the gaps or holes of the electronic product. This results in that it is difficult to re-assemble the locking structure 10 or may damage other elements of the electronic product.

What is needed, therefore, is a new locking assembly that can overcome the above-described shortcomings.

### SUMMARY

A locking assembly according to a preferred embodiment includes a locking member, an lock washer and a sleeve. The locking member includes a locking portion. A sleeve defines a through hole for holding and guiding the locking member. The lock washer is positioned in the through hole of the sleeve for preventing the locking portion of the locking member to slide out of the sleeve without an external force.

Other advantages and novel features will become more apparent from the following detailed description of the preferred embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present locking assembly. Moreover, in the drawings, like reference numerals designate corresponding parts throughout the several views, and all the views are schematic.

FIG. 1 is an exploded, isometric view of a locking assembly according to a first preferred embodiment of the present invention.

FIG. 2 is an assembled, side cross-sectional view of the locking assembly of FIG. 1, the locking assembly assembled with a first object.

FIG. 3 is an assembled, side cross-sectional view of a locking assembly according to a second preferred embodiment of the present invention.

FIG. 4 is an abbreviated, side cross-sectional view of a conventional locking assembly fixing two objects together.

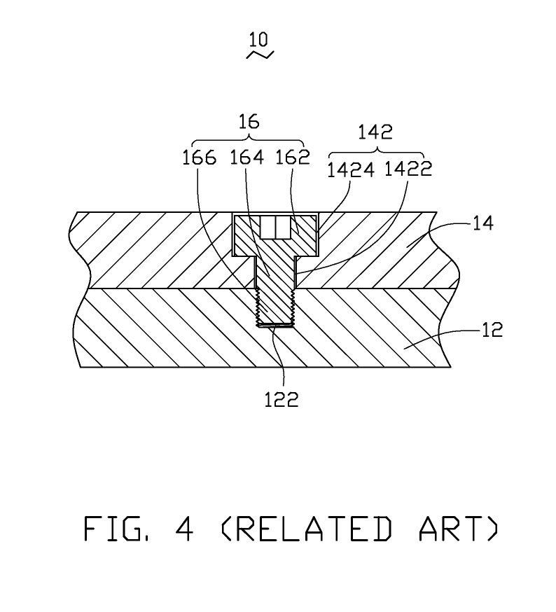

### DETAILED DESCRIPTION OF THE PREFERRED EMBODIMENTS

Reference will now be made to the drawings to describe, in detail, preferred embodiments of the present locking assembly.

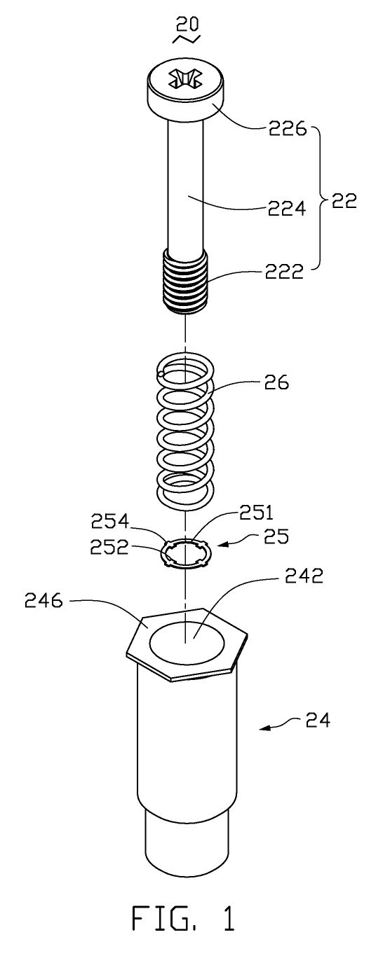

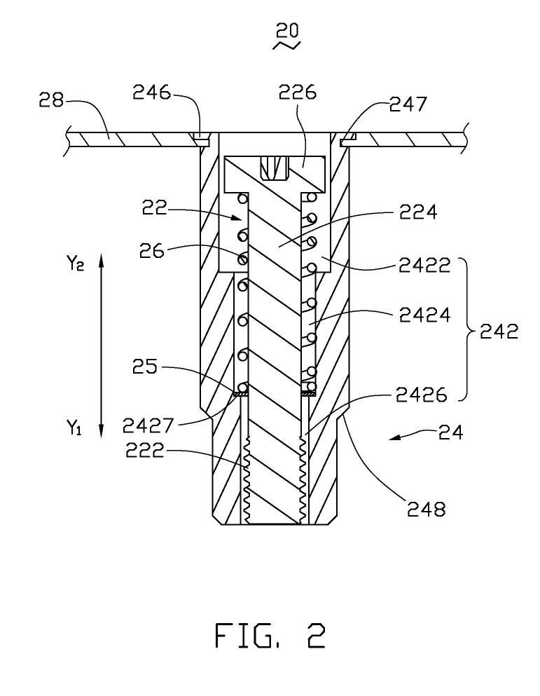

Referring to FIGS. 1 and 2, a locking assembly 20 in accordance with a first preferred embodiment of the present invention is shown. The locking assembly 20 is preferably used to fasten at least two metal (or plastic) sheets together, sheets such as electrical circuit boards, electronic devices, and computer components. The locking assembly 20 includes a fastener 22, a fastener sleeve 24, a lock washer 25, and a resilient member 26.

The fastener 22 is essentially a screw that includes a head portion 226, a neck portion 224, and a threaded portion 222. One end of the neck portion 224 connects to the head portion 226 and the other end of the neck portion 224 connects to the threaded portion 222. The threaded portion 222 of the fastener 22 defines outer screw threading. A maximum outer diameter of the threaded portion 222 of the fastener 22 is larger than that of the neck portion 224, and smaller than that of the head portion 226.

The fastener sleeve 24 is provided for holding and guiding the fastener 22. The fastener sleeve 24 is substantially a cylinder, which defines a through hole 242 along a center axis of the fastener sleeve 24. The through hole 242 includes three connecting parts in following order: a first part 2422, a second part 2424, and a third part 2426. In this embodiment, a depth of the through hole 242 of the fastener sleeve 24 is larger than the length of the fastener 22, the fastener sleeve 24 being configured for protecting the fastener 22 better. An inner diameter of the first part 2422 of the through hole 242 is larger than the outer diameter of the head portion 226. The fastener sleeve 24 defines a stepped portion 2427 between the second part 2424 and the third part 2426 of the through hole 242. An inner diameter of the second part 2424 of the through hole 242 is smaller than the outer diameter of the head portion 226, and respectively larger than the outer diameters of the neck portion 224 and the threaded portion 222. An inner diameter of the third part 2426 of the through hole 242 is smaller than that of the second part 2424, and respectively larger than or equal to the outer diameters of the neck portion 224 and the threaded portion 222. The head portion 226 of the fastener 22 can be blocked by the first part 2422 of the through hole 242 of the fastener sleeve 24.

The lock washer 25 includes a ring body 251, a plurality of inner elastic tabs 252 and a plurality of outer elastic tabs 254. The inner elastic tabs 252 protrude from an inner surface of the ring body 251 towards a center of the ring body 251. The outer elastic tabs 254 protrude from an outer surface of the ring body 251. In this embodiment, the number of inner elastic tabs 252 and outer elastic tabs 254 are four, respectively. A distance from a distal end of the inner elastic tabs 252 to the center of the ring body 25 is smaller than the maximum diameter of the threaded portion 222 of the fastener 22. A distance from a distal end of outer elastic tabs 254 to the center of the ring body 25 is larger than the inner diameter of the second part 2424 of the through hole 242. The lock washer 25 is configured for preventing the threaded portion 222 to slide out unless an external force is used. The external force must be greater than a resistance of the inner elastic tabs 252, thus preventing the fastener 22 to slide out of the fastener sleeve 24.

In this embodiment, the resilient member 26 is a spring. An outer diameter of the resilient member 26 is larger than the inner diameter of the third part 2426 of the through hole 242, but smaller than the inner diameter of the second part 2424 of the through hole 242. An inner diameter of the resilient member 26 is larger than the outer diameter of the threaded portion 222, but smaller than the diameter of the head portion 226 of the fastener 22.

In assembling, the lock washer 25 is pressed onto the stepped portion 2427 of the fastener sleeve 24, thereby the outer elastic tabs 254 resist the inner surface of the through hole 242 of the fastener sleeve 24. The resilient member 26 is disposed in the through hole 242 of the fastener sleeve 24 above the lock washer 25. When the fastener 22 is inserted into the through hole 242 along a Y₁-direction, the threaded portion 222 of the fastener 22 passes through the lock washer 25, and finally screwed into a threaded hole of a first object (not shown). The inner elastic tabs 252 of the lock washer 25 resist the neck portion 224 of the fastener 22. Therefore, the lock washer 25 can block the threaded portion 222 to slide out along an opposite direction (a Y₂-direction that is opposite to the Y₁-direction). If the fastener 22 is detached from the first object, the resilient member 26 produces a force pushing the fastener 22 upwards out of the fastener sleeve 24, but the lock washer 25 would block the fastener 22 from sliding out of the fastener sleeve 24. This configuration allows re-assembling the locking assembly 20 quickly. Alternatively, the resilient member 26 can be omitted. The depth of the through hole 242 of the fastener sleeve 24 can be equal to or smaller than the length of the fastener 22.

The fastener sleeve 24 further includes a flange portion 246 extending out from an outer surface thereof adjacent a distal end of the first part 2422 of the through hole 242. Preferably, the fastener sleeve 24 may further define a latching slot 247 in the outer surface adjoining the flange portion 246. A second object 28 defines an opening (not labeled). A maximum diameter of the flange portion 246 is larger than that of the opening of the second object 28. The fastener sleeve 24 with the fastener 22 partially passes through the opening of the second object 28. The second object 28 is attached to the latching slot 247. After the fastener 22 is screwed into the first object (not shown), the second object 28 is firmly resisted by the flange portion 246 of the fastener sleeve 24, such that the first object (not shown) and the second object 28 are fastened together. In an alternatively embodiment, the latching slot 247 of the fastener sleeve 24 can be omitted as long as the second object 28 defines a hole to contain the fastener sleeve 24 correspondingly.

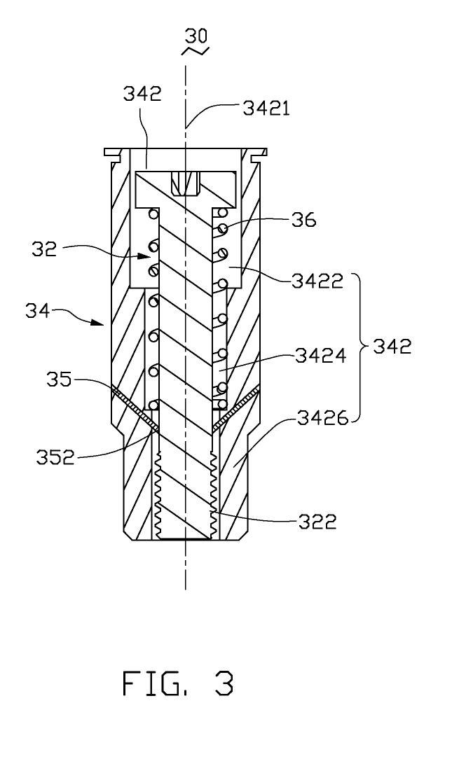

Referring to FIG. 3, a locking assembly 30 in accordance with a second preferred embodiment of the present invention is shown. The locking assembly 30 includes a fastener 32, a fastener sleeve 34, and a resilient member 36. The fastener 32 includes a head portion 326, a neck portion 324, and a threaded portion 322. The fastener sleeve 34 defines a through hole 342 along a center axis of the fastener sleeve 34. The through hole 342 includes three connecting parts in the following order: a first part 3422, a second part 3424, and a third part 3426. The locking assembly 30 is similar in principle to the locking assembly 20 of the first embodiment. However, the locking assembly 30 includes a plurality of restricting members 35 positioned in inner surface of the third part 3426 of the through hole 342 of the fastener sleeve 34. Each restricting member 35 has an elastic latch 352 extending into the through hole 342 and inclined toward the end of through hole 342 adjacent to the third part 3426. After the threaded portion 322 of the fastener 32 is pressed to pass through the second part 3424, the elastic latches 352 of the restricting members 35 can block the thread portion 322 of the fastener 32 to slide out from the fastener sleeve 34 unless an external force is used greater than a resistance of the elastic latches 352 of the restricting members 35.

It is to be understood that, the fastener 22, 32 can be replaced by any other locking members, the locking member having a locking portion and a neck portion connected to the locking portion. The lock portion can be one of latches or latching grooves that firmly mates with corresponding structures defined in object that will be fastened. It should be pointed out that the lock washer 244 can be an elastic ring body without elastic tabs, except that an inner diameter of the elastic ring body is smaller than the diameter of the threaded portion 222 of the fastener 22, and an outer diameter of the elastic ring body is larger than the inner diameter of the second part 2424 of the through hole 242. Alternatively, the resilient member 26, 36 can be omitted.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A locking assembly, comprising:
a locking member including a locking portion; and
a sleeve defining a through hole therein for holding and guiding the locking member;
a restricting member positioned in the through hole of the sleeve for preventing the locking portion of the locking member to slide out of the sleeve.

2. The locking assembly as claimed in claim 1, wherein the restricting member is a lock washer comprising a ring body, at least one inner elastic tab protruding from an inner surface of the ring body towards a center of the ring body, and at least one outer elastic tab protruding from an outer surface of the ring body.

3. The locking assembly as claimed in claim 2, wherein a distance from a distal end of the at least one inner elastic tab to the center of the ring body is smaller than the maximum diameter of the locking portion of the locking member.

4. The locking assembly as claimed in claim 2, wherein a distance from a distal end of the at least one outer elastic tab to a center of the ring body is larger than an inner diameter of the second part of the through hole.

5. The locking assembly as claimed in claim 3, wherein the locking member is a fastener, and the locking portion is a threaded portion; the fastener further comprises a head portion and a neck portion, one end of the neck portion connecting to the head portion and the other end of the neck portion connecting to threaded portion.

6. The locking assembly as claimed in claim 5, wherein a maximum outer diameter of the threaded portion of the fastener is larger than that of the neck portion, and smaller than that of the head portion.

7. The locking assembly as claimed in claim 5, wherein the through hole of the sleeve comprises three connecting parts in following order: a first part, a second part, and a third part; the sleeve further comprises a stepped portion defined between the second part and the third part; the lock washer is disposed on the stepped portion.

8. The locking assembly as claimed in claim 7, wherein an inner diameter of the first part of the through hole is larger than the outer diameter of the head portion.

9. The locking assembly as claimed in claim 7, wherein an inner diameter of the second part of the through hole is smaller than the outer diameter of the head portion, but larger than the outer diameter of the threaded portion.

10. The locking assembly as claimed in claim 7, wherein an inner diameter of the third part of the through hole is smaller than that of the second part, but larger than or equal to the outer diameter of the threaded portion.

11. The locking assembly as claimed in claim 7, further comprising a resilient member disposed in the through hole of the sleeve above the stepped portion.

12. The locking assembly as claimed in claim 11, wherein an outer diameter of the resilient member is larger than the inner diameter of the third part of the through hole, but smaller than the inner diameter of the second part of the through hole.

13. The locking assembly as claimed in claim 1, wherein an inner diameter of the resilient member is larger than the outer diameter of the threaded portion, but smaller than the diameter of the head portion of the fastener.

14. The locking assembly as claimed in claim 7, wherein the sleeve further comprises a flange portion extending out from an outer surface thereof adjacent a distal end of the first part of the through hole.

15. The locking assembly as claimed in claim 1, wherein the depth of the through hole of the sleeve is larger than or equal to the length of the locking member.

16. The locking assembly as claimed in claim 1, wherein the restricting member is positioned in an inner surface of the through hole of the sleeve, the restricting member comprising an elastic latch extending into the through hole and inclined toward one end of through hole.

17. The locking assembly as claimed in claim 1, wherein the restricting member is a locking washer, the lock washer is an elastic ring body, an inner diameter of the elastic ring body is smaller than the diameter of the locking portion of the locking member, and an outer diameter of the elastic ring body is larger than the inner diameter of the through hole, the lock washer is pressed into the through hole.

18. A locking assembly, comprising:
a locking member including a locking portion; and
a sleeve defining a through hole therein for holding and guiding the locking member, the through hole including a first part and a second part;
a restricting member positioned in the through hole of the sleeve, wherein after the locking portion of the locking member passes through the restricting member, the restricting member blocks the locking portion from sliding out of the sleeve.
